(19) United States
(12) Patent Application Publication
(10) Pub. No.: US 2023/0388978 A1
(43) Pub. Date: Nov. 30, 2023

(54) ELECTRONIC DEVICE AND METHOD FOR WIRELESS COMMUNICATION, AND COMPUTER-READABLE STORAGE MEDIUM

(71) Applicant: Sony Group Corporation, Tokyo (JP)

(72) Inventors: Min LIU, Beijing (CN); Jianfei CAO, Beijing (CN)

(73) Assignee: Sony Group Corporation, Tokyo (JP)

(21) Appl. No.: 18/031,622

(22) PCT Filed: Oct. 18, 2021
(86) PCT No.: PCT/CN2021/124296

§ 371 Date: Apr. 13, 2023

(30) Foreign Application Priority Data
Oct. 23, 2020 (CN) 202011145936.5

(51) Int. Cl. H04W 72/044; H04W 72/231

(52) U.S. Cl. CPC H04W 72/044; H04W 72/231

(57) ABSTRACT

The present disclosure provides an electronic device for wireless communication. The electronic device comprises a processing circuit. The processing circuit is configured to: receive, from a user equipment, reporting information about the capability of the user equipment to support multi-frequency domain resource transmission and multi-beam transmission; generate control signaling, wherein the control signaling comprises indication information for indicating frequency domain resources and beams used for communication with the user equipment, and the frequency domain resources and the beams have a binding relationship; and send the control signaling to the user equipment.

### TECHNICAL FIELD

The present disclosure relates to the technical field of wireless communications, particularly to indicating beams and frequency domain resources in a case where multi-frequency domain resource and multi-beam transmissions are supported and there is binding relationship between the beams and the frequency domain resources, and more particularly, to an electronic apparatus and method for wireless communications, and a computer-readable storage medium.

### BACKGROUND ART

In a wireless communications system including a Non-Terrestrial network (NTN), satellite equipment may generate a plurality of beams. Further, a PCI (Physical Cell ID) may correspond to a plurality of beams. As such, there is no need to perform cell switching during beam switching, thereby avoiding frequent operations such as synchronization and RRC (Radio Resource Control) reconnection and the like.

In the prior art (e.g., NR Rel.16), user equipment may report its own ability to support multi-beam simultaneous transmission to a base station. In the current NR standard, a base station may use beam(s) in any direction on frequency domain resource(s), but a specific beam may be used only on a specific frequency domain resource in a case where beam(s) have binding relationship with frequency domain resource(s). This makes some beam/frequency domain resource indication in the existing protocols no longer applicable.

### SUMMARY OF THE INVENTION

A brief summary of the present invention is given below, to provide a basic understanding of some aspects of the present invention. It should be understood that the following summary is not an exhaustive summary of the present invention. It does not intend to determine a key or important part of the present invention, nor does it intend to limit the scope of the present invention. Its object is only to present some concepts in a simplified form, which serves as a preamble of a more detailed description to be discussed later.

According to one aspect of the present disclosure, there is provided an electronic apparatus for wireless communications, the electronic apparatus comprising processing circuitry configured to: receive, from user equipment, report information about the ability of the user equipment to support multi-frequency domain resource transmission and multi-beam transmission; generate control signaling, wherein the control signaling includes indication information for indicating frequency domain resource(s) and beam(s) used to communicate with the user equipment, the frequency domain resource(s) and the beam(s) having binding relationship; and transmit the control signaling to the user equipment.

According to one aspect of the present disclosure, there is provided an electronic apparatus for wireless communications, the electronic apparatus comprising processing circuitry configured to: report, to network side equipment, first report information about the ability of the electronic apparatus to support multi-frequency domain resource transmission, and second report information about the ability of the electronic apparatus to support multi-beam transmission; and receive control signaling from the network side equipment, wherein the control signaling includes indication information for indicating frequency domain resource(s) and beam(s) used for the network side equipment to communicate with the electronic apparatus, wherein the frequency domain resource(s) and the beam(s) have binding relationship.

According to another aspect of the present disclosure, there is provided a method for wireless communications, the method comprising: receiving, from user equipment, report information about the ability of the user equipment to support multi-frequency domain resource transmission and multi-beam transmission; generating control signaling, wherein the control signaling includes indication information for indicating frequency domain resource(s) and beam(s) used to communicate with the user equipment, the frequency domain resource(s) and the beam(s) having binding relationship; and transmitting the control signaling to the user equipment.

According to another aspect of the present disclosure, there is provided a method for wireless communications, the method comprising: reporting, to network side equipment, first report information about the ability of the electronic apparatus to support multi-frequency domain resource transmission, and second report information about the ability of the electronic apparatus to support multi-beam transmission; and receiving control signaling from the network side equipment, wherein the control signaling includes indication information for indicating frequency domain resource(s) and beam(s) used for the network side equipment to communicate with the electronic apparatus, wherein the frequency domain resource(s) and the beam(s) have binding relationship.

According to other aspects of the present invention, there are further provided a computer program code and a computer program product for implementing the above-mentioned methods for wireless communications, as well as a computer-readable storage medium on which the computer program code for implementing the above-mentioned methods for wireless communications is recorded.

These and other advantages of the present invention will be more apparent through the following detailed description of preferred embodiments of the present invention in conjunction with the accompanying drawings.

### BRIEF DESCRIPTION OF THE DRAWINGS

In order to further set forth the above and other advantages and features of the present invention, specific embodiments of the present invention will be further described in detail below in conjunction with the accompanying drawings. The accompanying drawings together with the following detailed description are included in this specification and form a part of this specification. Elements with identical functions and structures are denoted by identical reference numerals. It should be understood that, these figures only describe typical examples of the present invention, and should not be regarded as limitations to the scope of the present invention. In the accompanying drawings:

FIG. 1 is a schematic diagram showing a scenario where each cell is configured with a plurality of beams according to an embodiment of the present disclosure;

FIG. 2A to FIG. 2D are schematic diagrams showing a scenario where beam(s) are bound to frequency domain resource(s) according to an embodiment of the present disclosure, respectively;

FIG. 3 shows a functional block diagram of an electronic apparatus for wireless communications according to one embodiment of the present disclosure;

FIG. 4 shows a functional module block diagram of an electronic apparatus for wireless communications according to another embodiment of the present disclosure;

FIG. 5 shows a flowchart of a method for wireless communications according to one embodiment of the present disclosure;

FIG. 6 shows a flowchart of a method for wireless communications according to another embodiment of the present disclosure;

FIG. 7 is a block diagram showing a first example of a schematic configuration of an eNB or gNB to which the technology of the present disclosure can be applied;

FIG. 8 is a block diagram showing a second example of a schematic configuration of an eNB or gNB to which the technology of the present disclosure can be applied;

FIG. 9 is a block diagram showing an example of a schematic configuration of a smart phone to which the technology of the present disclosure can be applied;

FIG. 10 is a block diagram showing an example of a schematic configuration of automobile navigation equipment to which the technology of the present disclosure can be applied;

FIG. 11 is a block diagram of an exemplary structure of a universal personal computer in which the methods and/or apparatuses and/or systems according to the embodiments of the present invention can be implemented.

### DETAILED DESCRIPTION OF THE EMBODIMENTS

Hereinafter, exemplary embodiments of the present disclosure will be described in conjunction with the accompanying drawings. For the sake of clarity and conciseness, the description does not describe all features of actual embodiments. However, it should be understood that in developing any such actual embodiment, many decisions specific to the embodiments must be made, so as to achieve specific objects of a developer; for example, those limitation conditions related to systems and services are satisfied, and these limitation conditions possibly will vary as embodiments are different. In addition, it should also be appreciated that, although developing work may be very complicated and time-consuming, such developing work is only routine tasks for those skilled in the art benefiting from the present disclosure.

It should also be noted herein that, to avoid the present invention from being obscured due to unnecessary details, only those apparatus structures and/or processing steps closely related to the solution according to the present invention are shown in the accompanying drawings, while omitting other details not closely related to the present invention.

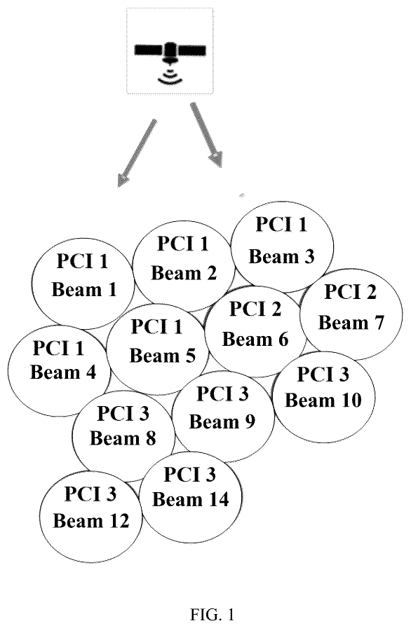

FIG. 1 is a schematic diagram showing a scenario where each cell is configured with a plurality of beams according to an embodiment of the present disclosure. As shown in FIG. 1, each PCI may correspond to a plurality of beams. For example, PCI1 may correspond to beam 1, beam 2, beam 3, beam 4 and beam 5, PCI2 may correspond to beam 6 and beam 7, and PCI3 may correspond to beam 8, beam 9, beam 10, beam 12 and beam 14.

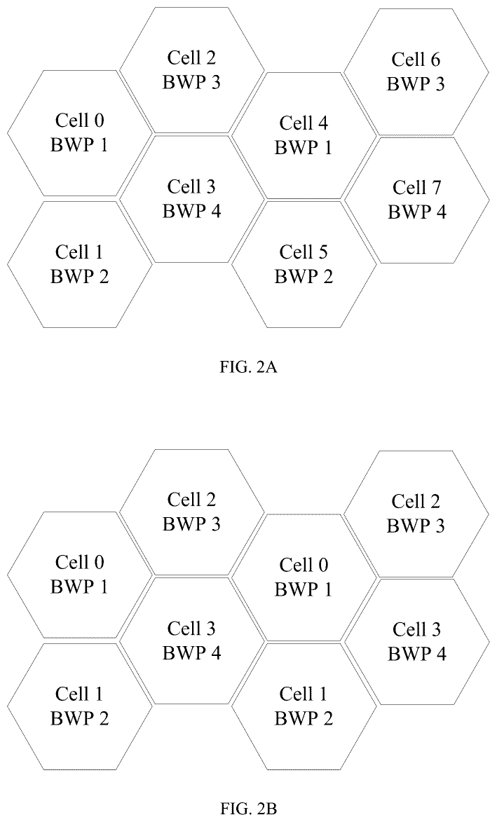

By binding frequency domain resource(s) and beam(s), the frequency domain resource(s) and the beam(s) may be made to have binding relationship, that is, a certain beam may be transmitted only on a certain frequency domain resource, and a certain frequency domain resource may simultaneously transmit a plurality of beams that are not adjacent, thereby making it possible to reduce interference between adjacent beams. In particular, when it is considered to use different antenna polarization directions for network deployment, a certain frequency domain resource may simultaneously transmit a plurality of adjacent beams, but at this time antenna polarization directions used by two adjacent beams are different. Indication of polarization directions may be included together with beams in indication information to perform indication. Embodiments of the present disclosure are also applicable to such a scenario. Examples of a scenario where beam(s) are bound to frequency domain resource(s) will be described below with reference to FIGS. 2A to 2D. Those skilled in the art could understand that a scenario where beam(s) are bound to frequency domain resource(s) is not limited to the examples as shown in FIG. 2A to FIG. 2D.

FIG. 2A to FIG. 2D are schematic diagrams showing a scenario where beam(s) are bound to frequency domain resource(s) according to an embodiment of the present disclosure, respectively.

FIG. 2A to FIG. 2D show the coverage of an NTN area, which is geographically divided into a plurality of cells. Here, although FIGS. 2A to 2D show an example in which a shape of each cell is a hexagon and a size of each cell is the same, the present disclosure is not limited thereto. Furthermore, each cell uses different beams due to a different spatial location. The frequency domain resource(s) are, for example, BWP(s) (Bandwidth Part(s)) and/or CC(s) (Component Carrier(s)).

As shown in FIG. 2A, there is only one BWP (represented by BWP 1-BWP 4 respectively) in each cell (cell IDs are Cell 0-Cell 7, respectively); for example, cell Cell 0 uses BWP 1, cell Cell 1 uses BWP 2, . . . , and Cell 7 uses BWP 4. Adjacent beams use different BWPs, and each beam may be uniquely determined from frequency domain resources (e.g., cell IDs). In this scenario, Carrier Aggregation (CA) must be supported in order to support multi-beam. In the CA scenario, a cell may be regarded as being a CC.

As shown in FIG. 2B, the same BWP ID corresponds to the same cell ID (for example, BWP 1 corresponds to the same cell ID Cell 0, BWP 2 corresponds to the same cell ID Cell 1, etc.), adjacent beams use different BWPs, beams of the same cell are not adjacent, and beams may be determined from frequency domain resources (cell IDs+BWP IDs).

As shown in FIG. 2C, each cell (for example, cell IDs are Cell 0 and Cell 1, respectively) contains 4 BWPs (BWP 1-BWP 4), each BWP corresponds to one beam, adjacent beams use different BWPs, and therefore, each beam may be uniquely determined from cell frequency domain resources (cell IDs+BWP IDs).

As shown in FIG. 2D, cell Cell 0 contains 8 beams and contains 4 BWPs (BWP 1-BWP 4), adjacent beams use different BWPs, and beams may be determined from frequency domain resources (cell IDs+BWP IDs).

With respect to the above scenario, the present disclosure proposes an electronic apparatus in a wireless communications system, a wireless communications method executed by the electronic apparatus in the wireless communications system, and a computer-readable storage medium, so as to perform indication for beam(s) and frequency domain resource(s) in a case where user equipment has the ability to support multi-frequency domain resource transmission and multi-beam transmission and the beam(s) and the frequency domain resource(s) have binding relationship.

The wireless communications system according to the present disclosure may be a 5G NR (New Radio) communications system. Further, the wireless communications system according to the present disclosure may include a NTN. Optionally, the wireless communications system according to the present disclosure may further include a TN (Terrestrial network).

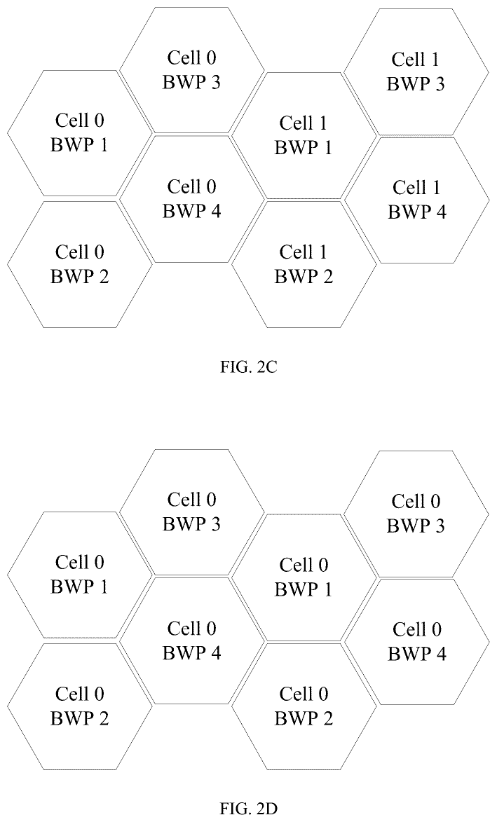

FIG. 3 shows a functional block diagram of an electronic apparatus 300 for wireless communications according to one embodiment of the present disclosure. As shown in FIG. 3, the electronic apparatus 300 comprises: a processing unit 301 configured to receive, from user equipment, report information about the ability of the user equipment to support multi-frequency domain resource transmission and multi-beam transmission; a generation unit 303 configured to generate control signaling, wherein the control signaling includes indication information for indicating frequency domain resource(s) and beam(s) used to communicate with the user equipment, the frequency domain resource(s) and the beam(s) having binding relationship; and a communication unit 305 configured to transmit the control signaling to the user equipment.

Wherein the processing unit 301, the generation unit 303 and the communication unit 305 may be implemented by one or more processing circuitries which may be implemented as, for example, a chip.

The electronic apparatus 300 may serve as network side equipment in a wireless communications system, and specifically, for example, may be arranged on base station side or communicably connected to a base station. It should also be noted herein that, the electronic apparatus 300 may be implemented at chip level or at device level. For example, the electronic apparatus 300 may work as a base station itself, and may also include external devices such as a memory, a transceiver (not shown in the figure) and the like. The memory may be used to store programs and related data information that the base station needs to execute in order to implement various functions. The transceiver may include one or more communication interfaces to support communication with different devices (e.g., user equipment, other base stations, etc.), and the implementation form of the transceiver is not specifically limited here.

As an example, the frequency domain resource(s) may include BWP(s) and/or CC(s). The BWP(s) may be frequency domain resource(s) with different BWP IDs in the same cell, and may also be frequency domain resource(s) corresponding to the same BWP ID in different cells.

In the existing standard, in order to reduce the complexity of user equipment (UE), it is limited that at the same timing only one uplink BWP and one downlink BWP can be activated in one cell. However, in the meantime the maximum number of CCs that the UE can support is 32. Therefore, in terms of the ability of the UE, by reducing the number of CCs used while increasing the number of BWPs supported, for example, if the number of CCs supported is 8 and the number of BWPs supported in each CC is 2, then the burden of radio frequency tuning is 16, the complexity of the UE is not increased on the whole. That is, the ability of the UE to support simultaneous multiple-frequency domain resource transmission and multiple-beam transmission (the UE has the ability to simultaneously use multiple (at least two) beams and multiple (at least two) frequency domain resources (e.g., BWPs and/or CCs)) to perform signal reception and transmission) will not increase the complexity of the UE.

As an example, hereinafter, the frequency domain resource(s) used for the electronic apparatus 300 to communicate with the user equipment includes a plurality of frequency domain resources and the beam(s) used for the electronic apparatus 300 to communicate with the user equipment includes a plurality of beams.

Hereinafter, description will be mainly made by taking the frequency domain resource(s) being BWP(s) as an example.

As an example, a special scenario is that: two adjacent beams may use the same BWP, but use different polarization directions. At this time, the polarization directions may be understood as special BWPs, and the polarization directions may be included together with the beams in the indication information to perform indication. Embodiments of the present disclosure are also applicable to such a scenario.

As an example, the control signaling may include control signaling for downlink control (i.e., signaling for controlling downlink transmission) and control signaling for uplink control (i.e., signaling for controlling uplink transmission). In the case where the control signaling is control signaling for downlink control, indication information about frequency domain resource(s) that is included in the control signaling is used to indicate downlink frequency domain resource(s), and indication information about beam(s) that is included in the control signaling is used to indicate downlink transmit beam(s). Similarly, in the case where the control signaling is control signaling for uplink control, indication information about frequency domain resource(s) included in the control signaling is used to indicate uplink frequency domain resource(s), and indication information about beam(s) included in the control signaling is used to indicate uplink transmit beam(s).

For the binding relationship between the frequency domain resource(s) and the beam(s), reference may be made to the descriptions made with regard to FIGS. 2A to 2D, that is, a certain beam may be transmitted only on a certain BWP, and a certain BWP may simultaneously transmit a plurality of beams that are not adjacent.

The electronic apparatus 300 may configure the binding relationship between the frequency domain resource(s) and the beam(s). As an example, there is binding relationship between the downlink frequency domain resource(s) and the downlink transmit beam(s), and there is binding relationship between the uplink frequency domain resource(s) and the uplink transmit beam(s). Further, the electronic apparatus 300 may transmit such binding relationship to the user equipment.

NR Rel.16 in the prior art supports beam activation/indication across CCs/BWPs. For example, on a BWP with an ID being BWP #1 there is a CORESET (control-resource set) with IDs being coreset #1 and coreset #2, on a BWP with an ID being BWP #2 there is a CORESET of coreset #1 and coreset #2, and if the current activated BWP is BWP #1 and a beam with an ID being beam #3 has been activated to perform PDCCH (Physical Downlink Control Channel) blind detection for Coreset #1 on BWP #1, then a beam corresponding to coreset #1 on BWP #2 is also beam #3. The benefit of such doing is that, when the activated BWP of the UE is switched from BWP #1 to BWP #2, in a case where CORESET ID is still used invariantly, the beam does not need to be reactivated and can be used directly. Such a configuration has no problem in a case where the beam(s) have no binding relationship with the BWP(s), because any beam may be used on any BWP; for example in the above example, beam #3 may be used not only on BWP #1 but also on BWP #2. Even in a case where the beam(s) have binding relationship with the BWP(s), it is also possible if only a single BWP/single CC is used in the system, because at this time only one beam/BWP is in use, except for the necessity of ensuring that the beam is re-switched while the BWP is switched each time. However, in a case where the BWP(s) have binding relationship with the beam(s) and a plurality of beams is simultaneously used, the above-mentioned triggering mechanism is no longer applicable.

However, the electronic apparatus 300 according to the embodiment of the present disclosure can correctly perform indication for beam(s) and frequency domain resource(s) in a case where multi-frequency domain resource and multi-beam transmissions are supported and the beam(s) and the frequency domain resource(s) have binding relationship.

As an example, the indication information for indicating the frequency domain resource(s) and the beam(s) used for the electronic equipment to communicate with the user equipment may separately indicate the frequency domain resource(s) and the beam(s), and may also jointly indicate the frequency domain resource(s) and the beam(s).

Hereinafter, the case where the indication information for indicating the frequency domain resource(s) and the beam(s) used for the electronic equipment to communicate with the user equipment separately indicate the frequency domain resource(s) and the beam(s) will be described first.

As an example, the indication information may include frequency domain indication information for indicating the frequency domain resource(s) and beam indication information for indicating the beam(s), and the frequency domain resource(s) indicated by the frequency domain indication information are the same as frequency domain resource(s) where reference signals included in the beam indication information lie, or are the same as frequency domain resource(s) where reference signals having a quasi-colocation relationship with the reference signals lie.

As an example, the frequency domain indication information may include identification information of the frequency domain resource(s). For example, in a case where the frequency domain resource(s) are BWP(s), the frequency domain indication information may be BWP ID(s).

As an example, the beam(s) may be represented by reference signal(s) (see TS 38.331). For example, downlink transmission beam(s) may be represented by downlink reference signal(s), which include but are not limited to SSB(s) (Synchronization Signal Block(s)) and CSI-RS(s) (Channel State Information-Reference Signal(s)). For a BWP (also referred to as BWP 0) for initial access, all SSBs may be transmitted on this BWP 0. That is, the user equipment performs synchronization by detecting SSBs on BWP 0. For SSBs of the same cell, the SSBs do not need to be described by frequency domain resources BWPs. For BWPs other than the BWP 0, they have a corresponding relationship with the beams represented by the CSI-RSs, and it may also be said that the CSI-RSs need to be described by the frequency domain resources BWPs.

As an example, that two different reference signals have a quasi-colocation relationship means that: the two reference signals are different, but the beams represented by the two reference signals are the same or related.

CSI-RSs may establish a quasi-colocation relationship with SSBs. In a case where the reference signals are SSBs, the frequency domain resource(s) indicated by the frequency domain indication information are the same as frequency domain resource(s) where CSI-RSs having a quasi-colocation relationship with the SSBs lie. By way of example but not limitation, it is assumed that BWP 2 has a corresponding relationship with a beam represented by a CSI-RS, that is, the CSI-RS may be described by the frequency domain resource BWP 2. Then in the case where the reference signals are SSBs, the BWP(s) indicated by the frequency domain indication information are the same as the BWP 2 where CSI-RSs having a quasi-colocation relationship with the SSBs lie.

In a case where the reference signals are CSI-RSs, the BWP(s) indicated by the frequency domain indication information are the same as BWP(s) (since the CSI-RSs are downlink reference signals, the BWPs corresponding thereto are downlink BWPs) where the CSI-RSs lie. For the above-mentioned example in which the CSI-RS may be described by the frequency domain resource BWP 2, the BWP(s) indicated by the frequency domain indication information are the same as the BWP 2 where CSI-RSs lie. If uplink communication and downlink communication use the same frequency domain resource(s), the BWP 2 is used for uplink communication and downlink communication.

The beam indication information for indicating the downlink transmit beams may be TCI (Transmission Configuration Indicator) states, which is because that the TCI states have a corresponding relationship with the downlink reference signals, and thus unique downlink reference signals of a quasi-colocation type D (QCL type D) may be determined according to the TCI states, so that the downlink transmit beams may be determined.

Similarly, the uplink transmit beams may be represented by uplink reference signals which are, for example, SRSs. The beam indication information for indicating the uplink transmit beams may be SpatialRelationInfo (Spatial Relationship Information) or SRIs (SRS Resource Indicators), which is because that SpatialRelationInfo or SRIs have a corresponding relationship with the uplink reference signals SRSs or the downlink reference signals such as CSI-RSs, and thus unique uplink reference signals or downlink reference signals may be determined according to SpatialRelationInfo or SRIs, so that the uplink transmit beams may be determined. In addition, the beam indication information for indicating the uplink transmit beams may also be TCIs.

SRSs need to be described by the frequency domain resources BWPs. In addition, SRSs may establish a QCL relationship with SSBs. In the case where the reference signals are SRSs, the BWP(s) indicated by the frequency domain indication information are the same as BWP(s) (since the SRSs are uplink reference signals, the BWPs corresponding thereto are uplink BWPs) where the SRSs lie.

When the downlink reference signals are CSI-RSs, if uplink communication and downlink communication use different frequency domain resources, in a case where the electronic apparatus 300 has informed the user equipment of pairing between uplink and downlink resources in advance, the user equipment can find uplink BWP(s) corresponding to downlink BWP(s) (for example, BWP 2) where the CSI-RSs lie to perform activation.

Hereinafter, description will be made by taking the case where the control signaling is control signaling for downlink control and the downlink transmit beams are represented by downlink reference signals as an example.

As an example, in the case where the control signaling is control signaling for downlink control, after the electronic apparatus 300 configures the binding relationship between the downlink transmit beam(s) and the downlink frequency domain resource(s), the generation unit 303 may generate control signaling, which may include BWP ID(s) and TCI state(s). By making the downlink BWP(s) as indicated by the BWP ID(s) be the same as BWPs where reference signals included in the TCI state(s) lie, or be the same as BWP(s) where reference signals having a quasi-colocation relationship with the reference signals lie, the downlink BWP(s) as indicated by the BWP ID(s) are the same as downlink BWP(s) corresponding to the downlink transmit beam(s) as indicated by the TCI state(s).

As can be seen, in the electronic apparatus 300 according to the embodiment of the present disclosure, the control signaling includes frequency domain indication information and beam indication information, and the frequency domain resource(s) indicated by the frequency domain indication information are the same as frequency domain resource(s) where reference signals included in the beam indication information lie, or are the same as frequency domain resource(s) where reference signals having a quasi-colocation relationship with the reference signals lie. As such, it is possible to correctly perform indication for the beam(s) and the frequency domain resource(s) in a case where the beam(s) are bound to the frequency domain resource(s), so as to prevent the user equipment from failure of normal reception or transmission which results from difference(s) between the frequency domain resource(s) indicated by the frequency domain indication information and the frequency domain resource(s) corresponding to the beam(s) indicated by the beam indication information.

As an example, the communication unit 305 may be configured to use the beam(s) to transmit control signals on the frequency domain resource(s) to form a control channel between the electronic apparatus 300 and the user equipment, and/or to use the beam(s) to transmit data signals on the frequency domain resource(s) to form a data channel between the electronic apparatus 300 and the user equipment. In the case where the user equipment has the ability to support multi-beam transmission and multi-BWP transmission, the electronic apparatus 300 may instruct the user equipment to use at least one beam on at least one BWP to perform control channel blind detection, and to use at least one beam on at least one BWP to perform data channel demodulation.

As an example, the control channel between the electronic apparatus 300 and the user equipment may include an uplink control channel and a downlink control channel, and the data channel between the electronic apparatus 300 and the user equipment may include an uplink data channel and a downlink data channel.

Taking the control signaling being control signaling for downlink control as an example, the control channel between the electronic apparatus 300 and the user equipment is used to transmit downlink control information, and the data channel between the electronic apparatus 300 and the user equipment is used to transmit downlink data information. The control signaling may include frequency domain indication information BWP ID(s) and beam indication information TCI state(s). It is possible to use the frequency domain indication information BWP ID(s) to indicate downlink frequency domain resource(s) for downlink data information (borne by PDSCH(s)) and downlink control information (borne by PDCCH(s)), and it is possible to use the beam indication information TCI state(s) to indicate downlink transmit beam(s) for downlink data information.

As an example, the communication unit 305 may be configured to use, on at least one frequency domain resource among the plurality of frequency domain resources, one beam bound to the at least one frequency domain resource to transmit the control signal to form the control channel, and the control signaling includes a Media Access Control-Control element MAC CE. For example, in a case where the electronic apparatus 300 configures the user equipment to use, on one BWP, one beam bound to the one BWP to perform control channel reception and transmission, the electronic apparatus 300 may use MAC CE signaling that includes frequency domain indication information BWP D(s) indicating the one BWP and beam indication information indicating the one beam, to perform indication of frequency domain resource(s) and beam(s) to the user equipment. For example, in a case where the electronic apparatus 300 configures the user equipment to use, on at least two BWPs, beam(s) bound to the at least two BWPs to perform control channel reception and transmission, the electronic apparatus 300 may use MAC CE signaling that includes frequency domain indication information BWP ID(s) indicating the at least two BWPs and beam indication information indicating the beam(s) bound to the at least two BWPs, to perform indication of frequency domain resource(s) and beam(s) to the user equipment.

In the prior art, for the control channel, beam indication is performed through a MAC CE. For multi-beam indication for the control channel, in the prior art, beam indication is performed for a CORESET pool respectively. However, in the prior art, the MAC CE cannot be used to indicate frequency domain resource(s) (e.g., BWP(s)), that is, the MAC CE does not include frequency domain indication information (e.g., BWP ID(s)). In the embodiments according to the present disclosure, however, the MAC CE is used to indicate frequency domain resource(s) (e.g., BWP(s)), that is, the MAC CE includes frequency domain indication information (e.g., BWP ID(s)).

As an example, the communication unit 305 may be configured to use, on one frequency domain resource among the plurality of frequency domain resources, a beam bound to the one frequency domain resource to transmit the control information to form the control channel, and to explicitly or implicitly notify, in the control signaling, that the control signaling is used to indicate attribute information of a specific control channel, wherein the control signaling includes Downlink Control Information DCI. For example, in a case where the electronic apparatus 300 configures the user equipment to use, on one BWP, a beam bound to the one BWP to perform control channel reception and transmission, the electronic apparatus 300 may use DCI signaling that includes frequency domain indication information BWP ID(s) and beam indication information TCI state(s) to perform indication of frequency domain resource(s) and beam(s) to the user equipment, and explicitly or implicitly notify, in the DCI signaling, that the DCI signaling is used to indicate attribute information of a specific control channel.

According to the existing standard, beam configuration for the control channel is by way of allocating one beam to each CORESET, the CORESET being a part of time-frequency resources, the user equipment performing PDCCH blind detection on this resource, the DCI being carried by PDCCHs. That is, all the PDCCHs transmitted in this part of the CORESET are demodulated using this beam. Therefore, for beam indication for the control channel, the user equipment needs to know which beam is used in which CORESET, for example, attribute information of a specific control channel may be CORESET ID(s). By indicating the CORESET ID(s) and beam information by the DCI, the user equipment knows which beam is used to perform PDCCH blind detection in the CORESET.

As stated above, in the prior art, for the control channel, beam indication is performed through a MAC CE. In the embodiments according to the present disclosure, beam indication for the control channel by the DCI has been newly added, that is, beam indication information is included in the DCI. As stated above, in a case where beam indication for the control channel is included in the DCI, it is explicitly or implicitly notified, in the DCI signaling, that the DCI signaling is used to indicate attribute information of a specific control channel.

As an example, the communication unit 305 may be configured to use, on at least two frequency domain resources among the plurality of frequency domain resources, beam(s) bound to the at least two frequency domain resources to transmit the control information to form the control channel or to transmit the data information to form the data channel, a value of a field indicating an ID of the frequency domain resource in the control signaling corresponds to ID(s) of at least one frequency domain resource among the plurality of frequency domain resources, and the control signaling includes DCI. For example, in a case where the electronic apparatus 300 configures the user equipment to use, on at least two frequency domain resources among the plurality of frequency domain resources, beam(s) bound to the at least two frequency domain resources to transmit the control information to form the control channel or to transmit the data information to form the data channel, a value (which, for example, may be represented by a BWP codepoint) of a field (e.g., BWP ID) indicating an ID of the frequency domain resource in the DCI corresponds to at least one BWP ID (for example, the BWP IDs include BWP 0, BWP 1 and BWP 2). By way of example but not limitation, in a case where the BWP ID field is 2 bits, the value being 00 of the BWP ID field corresponds to BWP 0, the value being 01 of the BWP ID field corresponds to BWP 1, the value being 10 of the BWP ID field corresponds to BWP 0 and BWP 2, and the value being 11 of the BWP ID field corresponds to BWP 0, BWP 1 and BWP 2. In addition, the beam indication information is borne using field(s) indicating beam(s) in the DCI, thereby indicating the beam(s) (multi-beam(s)) bound to the at least two frequency domain resources.

In the prior art, the data channel performs beam indication through the DCI, and BWP switching may also be performed through the DCI. In the DCI in the prior art there is a field for indicating a BWP ID, and meanwhile in the DCI there is a field for indicating a beam, and meanwhile the prior art also supports that one TCI codepoint corresponds to a plurality of beams; therefore, in the embodiments of the present disclosure, by the fact that one BWP codepoint in the DCI corresponds to a plurality of BWP IDs, multi-frequency domain resource representation can be performed in the DCI.

As an example, the communication unit 305 may be configured to notify in advance the user equipment of a corresponding relationship between the value of the field indicating the ID of the frequency domain resource and the above-mentioned at least one frequency domain resource.

As an example, the communication unit 305 may be configured to perform the above-mentioned notification through RRC signaling and/or MAC CE signaling.

In the prior art, the base station performs a downlink/uplink dynamic scheduling through the DCI, and thus the scheme in which one BWP codepoint in the DCI corresponds to a plurality of BWP IDs in the embodiments of the present disclosure may be directly applied to the downlink/uplink dynamic scheduling; also, in the prior art, the base station may activate a down/uplink semi-persistent scheduling through the DCI, and thus the scheme in which one BWP codepoint in the DCI corresponds to a plurality of BWP IDs in the embodiments of the present disclosure may be directly applied to the down/uplink semi-persistent scheduling that needs the DCI activation. That is, the electronic apparatus 300 may use the above-mentioned DCI to transmit indication about the frequency domain resource(s) and beam(s).

In the prior art, there is also a semi-persistent scheduling that does not need the DCI activation. In the semi-persistent scheduling that does not need the DCI activation, the user equipment cannot receive the DCI, and therefore, the electronic apparatus 300 cannot transmit indication about frequency domain resource(s) and beam(s) through DCI signaling.

As an example, the communication unit 305 may be configured to: for a semi-persistent scheduling that does not need the DCI activation, include information about spectrum resource(s) and information about beam(s) in RRC signaling. For example, for the semi-persistent scheduling that does not need the DCI activation for a downlink/uplink, since the user equipment cannot receive the DCI in the semi-persistent scheduling, the electronic apparatus 300 directly includes information about spectrum resource(s) and information about beam(s) in RRC signaling.

As an example, in a case of using, on at least two frequency domain resources, beam(s) bound to the at least two frequency domain resources to transmit the control information to form the control channel, the communication unit 305 may be configured to explicitly or implicitly notify, in the control signaling, that the DCI signaling is used to indicate attribute information of a specific control channel. For example, in a case where the electronic apparatus 300 configures the user equipment to use, on at least two BWPs, beam(s) bound to the at least two BWPs to perform control channel reception and transmission, the electronic apparatus 300 may use DCI signaling that includes frequency domain indication information BWP ID(s) and beam indication information TCI state(s) to perform indication of frequency domain resource(s) and beam(s) to the user equipment, and, since multi-beam indication for the control channel is included in the DCI, explicitly or implicitly notify, in the DCI signaling, that the DCI signaling is used to indicate attribute information of a specific control channel.

As an example, the communication unit 305 may be configured to: when performing activation for candidate beam(s), if the candidate beam(s) include reference signals that need to be described by frequency domain resources, activate the frequency domain resources for describing the reference signals, or if the candidate beam(s) include reference signals that do not need to be described by frequency domain resources, activate frequency domain resource(s) where reference signals having a quasi-colocation relationship with the reference signals lie.

Description will be made by taking the reference signals being downlink reference signals as an example. The downlink reference signals include, but are not limited to, SSBs and CSI-RSs, and the CSI-RSs may establish a quasi-colocation relationship with the SSBs.

For a BWP (also referred to as BWP 0) for initial access, all SSBs may be transmitted on this BWP 0. The SSBs are an example of the reference signals that do not need to be described by frequency domain resources; and if the candidate beam(s) include SSBs, BWP(s) where reference signals CSI-RSs having a quasi-colocation relationship with the SSBs lie are activated.

For BWPs other than the BWP 0, they have a corresponding relationship with the beams represented by the CSI-RSs. The CSI-RSs are an example of the reference signals that need to be described by frequency domain resources; if the candidate beam(s) include CSI-RSs, the BWP(s) for describing the CSI-RSs are activated. Assuming that BWP 2 has a corresponding relationship with a beam represented by a CSI-RS, if the candidate beams include the CSI-RS, the BWP2 for describing the CSI-RS is activated.

Hereinafter, a case where the indication information for indicating frequency domain resource(s) and beam(s) used for the electronic apparatus to communicate with the user equipment jointly indicates the frequency domain resource(s) and the beam(s) will be described.

As an example, the indication information in the control signaling includes common indication information for jointly indicating the frequency domain resource(s) and the beam(s).

In the embodiments of the present disclosure, the frequency domain resources and beams may be jointly indicated in the control signaling through the common indication information.

As an example, the generation unit 303 may be configured to include information about the beam(s) in configuration information about the frequency domain resource(s) in the control signaling, so that the configuration information forms the common indication information, and the control signaling is RRC signaling. For example, when the electronic apparatus 300 performs a configuration for BWPs of the user equipment, the electronic apparatus 300 includes beam information (e.g., TCI states) in BWP configuration information when it uses a RRC configuration.

As an example, the generation unit 303 may be configured to include information about the frequency domain resource(s) in configuration information about the beam(s) in the control signaling, so that the configuration information forms the common indication information. For example, when the electronic apparatus 300 performs a configuration for beams of the user equipment, it includes BWP(s) where reference signals CSI-RSs in the TCI states lie, as the information about the frequency domain resource(s), in the configuration information about the beam(s), such as the TCI state(s).

As an example, the common indication information includes a predefined information pair for jointly indicating the frequency domain resource(s) and the beam(s). For example, the electronic apparatus 300 configures a special information pair for the user equipment, which not only includes configuration information of the BWP(s) (e.g., starting bandwidth, frequency bandwidth, etc.) but also includes configuration information of the beam(s) (e.g., beam ID, reference signal information, which may also include frequency offset compensation information, timing advance information and the like for the beams). As an example, the communication unit 305 may be configured to use the beam(s) to transmit control information on the frequency domain resource(s) to form a control channel between the electronic apparatus 300 and the user equipment, and/or use the beam(s) to transmit data information on the frequency domain resource(s) to form a data channel between the electronic apparatus 300 and the user equipment.

As an example, the control signaling may include a MAC CE or DCI, to indicate the frequency domain resource(s) and the beam(s) that form the control channel. That is, for the control channel, the electronic apparatus 300 may use the downlink signaling such as the MAC CE or DCI to perform indication of the frequency domain resource(s) and the beam(s) to the user equipment in the form of information pairs.

As an example, the control signaling includes DCI, to indicate the frequency domain resource(s) and the beam(s) that form the data channel. That is, for the data channel, the electronic apparatus 300 may use the downlink signaling DCI to perform indication of the frequency domain resource(s) and the beam(s) to the user equipment in the form of information pairs.

As an example, a value of a field indicating the information pair that is included in the control signaling corresponds to at least one information pair. For example, a certain field in the DCI, such as a beam-BWP field, may be used to indicate the information pair. The value of the field (which may be represented by a codepoint) may correspond to one or more sets of information pairs. For example, the beam-BWP field may replace the fields in the prior art, such as a BWP field and a TCI field.

As an example, the communication unit 305 may be configured to configure a corresponding relationship between the value of the field indicating the information pair and the at least one information pair through RRC signaling and/or MAC CE signaling.

As an example, the generation unit 303 may be configured to instruct the user equipment to perform channel measurement(s) on frequency domain resource(s) having been activated, and generate the control signaling based on result(s) of the channel measurement(s) reported by the user equipment. For example, the electronic apparatus 300 may configure the user equipment to perform beam/channel measurement(s) on a plurality of BWPs having been activated, and the user equipment reports measurement result(s) after the measurement(s) to the electronic apparatus 300. The electronic apparatus 300 determines the frequency domain resource(s) and the beam(s) used to communicate with the user equipment, according to the reported result(s), thereby generating the indication information in the control signaling, so as to perform multi-frequency domain resource/multi-beam indication.

As an example, the generation unit 303 may be configured to generate the control signaling based on location information reported by the user equipment and location information or track information of the electronic apparatus 300. For example, the electronic apparatus 300 may configure the user equipment to report location information. The electronic apparatus 300 determines the frequency domain resource(s) and the beam(s) used to communicate with the user equipment, according to the reported result(s) and its own location or track information, thereby generating the indication information in the control signaling, so as to perform multi-frequency domain resource/multi-beam indication.

As an example, the generation unit 303 may be configured to generate the control signaling based on a service type of the user equipment. For example, the electronic apparatus 300 may configure the user equipment to report a service type, and then determine the frequency domain resource(s) and the beam(s) used to communicate with the user equipment, according to the service type of the user equipment, thereby generating the indication information in the control signaling, so as to perform multi-frequency domain resource/multi-beam indication. For example, a urllc (ultra-reliable low-latency communication) service is to be transmitted, and at this time the electronic apparatus 300 may configure a plurality of beams for PDCCH transmission to achieve spatial diversity gain, so as to improve transmission reliability.

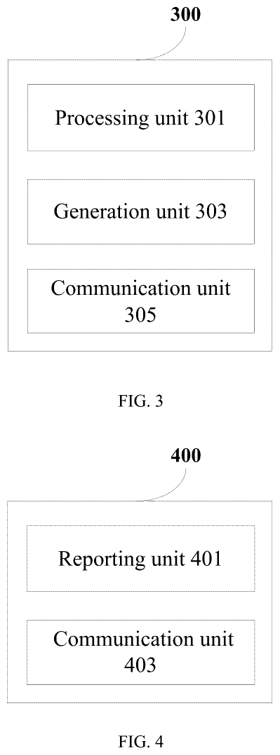

The present disclosure further provides an electronic apparatus for wireless communications according to another embodiment. FIG. 4 shows a functional module block diagram of an electronic apparatus 400 for wireless communications according to another embodiment of the present disclosure. As shown in FIG. 4, the electronic apparatus 400 comprises: a reporting unit 401, which may be configured to report, to network side equipment, first report information about the ability of the electronic apparatus 400 to support multi-frequency domain resource transmission, and second report information about the ability of the electronic apparatus 400 to support multi-beam transmission; and a communication unit 403, which may be configured to receive control signaling from the network side equipment, wherein the control signaling includes indication information for indicating frequency domain resource(s) and beam(s) used for the network side equipment to communicate with the electronic apparatus 400, wherein the frequency domain resource(s) and the beam(s) have binding relationship.

Wherein the reporting unit 401 and the communication unit 403 may be implemented by one or more processing circuitries which may be implemented as, for example, a chip.

The electronic apparatus 400 may be, for example, arranged on user equipment (UE) side or communicably connected to user equipment. It should also be noted herein that, the electronic apparatus 400 may be implemented at chip level or at device level. For example, the electronic apparatus 400 may work as user equipment itself, and may also include external devices such as a memory, a transceiver (not shown in the figure) and the like. The memory may be used to store programs and related data information that the user equipment needs to execute in order to implement various functions. The transceiver may include one or more communication interfaces to support communication with different devices (e.g., user equipment, other user equipment, etc.), and the implementation form of the transceiver is not specifically limited here. The base station may be, for example, an eNB or gNB.

As an example, the network side equipment may be a base station; for example, the network side equipment may be the electronic apparatus 300 according to the embodiment of the present disclosure.

In the existing standard, in order to reduce the complexity of user equipment, it is limited that at the same timing only one uplink BWP and one downlink BWP can be activated in one cell. However, in the meantime the maximum number of CCs that the UE can support is 32. Therefore, in terms of the ability of the UE, by reducing the number of CCs used while increasing the number of BWPs supported, for example, if the number of CCs supported is 8 and the number of BWPs supported in each CC is 2, then the burden of radio frequency tuning is 16, the complexity of the UE is not increased on the whole. That is, the ability of the UE to support simultaneous multiple-frequency domain resource transmission and multiple-beam transmission will not increase the complexity of the UE.

For the frequency domain resource(s), the beam(s), and the binding relationship between the frequency domain resource(s) and the beam(s), which will no longer be repeatedly described herein, reference may be made to the descriptions of the corresponding portions with regard to FIGS. 2A to 2D in the embodiment of the electronic apparatus 100.

The electronic apparatus 400 according to the embodiment of the present disclosure can receive correct indication for the beam(s) and the frequency domain resource(s) from the network side equipment in a case where multi-frequency domain resource and multi-beam transmissions are supported and the beam(s) and the frequency domain resource(s) have binding relationship.

In the prior art (e.g., NR Rel.16), the user equipment may report its own ability to support simultaneous multi-beam transmission to the network side equipment. In the embodiment of the present disclosure, the electronic apparatus 400 may further report its own ability to support multiple BWPs or ability to joint BWPs and CCs (e.g., the number of all activated BWPs including all serving cells) to the network side equipment.

As an example, the reporting unit 401 may be configured to report the first report information and the second report information, respectively.

As an example, the reporting unit 401 may be configured to transmit the first report information or the second report information in a scenario where beam(s) are bound to frequency domain resource(s). For example, in a case where a deployment scenario in which a specific beam is bound to a specific frequency domain resource is present in the system, the electronic apparatus 400 displays/implicitly reports the ability to support multi-beam transmission to the base station, thereby implicitly informing the base station that the electronic apparatus has the ability to support multi-frequency domain resource transmission. Vice versa.

As an example, the second report information includes information that the electronic apparatus 400 has a plurality of transceiver antenna panels, so as to implicitly reflect the ability of the electronic apparatus 400 to support multi-beam transmission.

As an example, the reporting unit 401 may be configured to explicitly report two abilities to the base station, respectively: the UE reports the ability that it is capable of supporting simultaneous multi-beam transmission to the base station, and also, the UE reports the ability that it is capable of simultaneous transmission on a plurality of frequency domain resources to the base station.

As an example, the reporting unit 401 may be configured to simultaneously report the first report information and the second report information. For example, the reporting unit 401 may simultaneously report the first report information and the second report information utilizing the information mentioned in describing the electronic apparatus 300.

As an example, the frequency domain resource(s) include(s) a plurality of frequency domain resources, and the communication unit 403 may be configured to: in a case of using only one frequency domain resource among the plurality of frequency domain resources for a downlink control channel between the network side equipment and the electronic apparatus 400, use the one frequency domain resource as a downlink primary frequency domain resource, and use a downlink frequency domain resource for a data channel between the network side equipment and the electronic apparatus 400 as a downlink secondary frequency domain resource. For example, when the electronic apparatus 400 is configured to perform control channel reception and transmission on one BWP and perform data channel reception and transmission on a plurality of BWPs, the electronic apparatus 400 may consider that a BWP where a transmission control channel lies is a downlink primary BWP, and that a BWP of the transmission data channel that is different from the downlink primary BWP is a downlink secondary BWP.

As an example, the communication unit 403 may be configured to: in a case where frequency domain resources for uplink communication have a corresponding relationship with frequency domain resources for downlink communication, use a frequency domain resource for uplink communication that corresponds to the downlink primary frequency domain resource as an uplink primary frequency domain resource, and use a frequency domain resource for uplink communication that corresponds to the downlink secondary frequency domain resource as an uplink secondary frequency domain resource. For example, when uplink BWPs for uplink communication and downlink BWPs for downlink communication are paired (including, but not limited to, time division duplex TDD), the electronic apparatus 400 considers that an uplink BWP corresponding to the downlink primary BWP is an uplink primary BWP, and that an uplink BWP corresponding to the downlink secondary BWP is an uplink secondary BWP.

As an example, the communication unit 403 may be configured to: in a case where frequency domain resources for uplink communication have no corresponding relationship with frequency domain resources for downlink communication, use a frequency domain resource for an uplink control channel that is indicated by the network side equipment as an uplink primary frequency domain resource. For example, when uplink BWPs for uplink communication and downlink BWPs for downlink communication are not paired (including, but not limited to, frequency division duplex FDD), the electronic apparatus 400 considers that a BWP where a PUCCH (Physical Uplink Control Channel) indicated by the base station lies is used as an uplink primary BWP. Wherein in the case where uplink BWPs for uplink communication and downlink BWPs for downlink communication are not paired, when downlink communication works on multiple BWPs, uplink communication may use either a single BWP or a plurality of BWPs.

In the process of describing the electronic apparatuses for wireless communications in the above implementations, some processing or methods obviously have also been disclosed. Hereinafter, an outline of these methods will be given without repeating some of the details that have been discussed above; however, it should be noted that, although these methods are disclosed in the process of describing electronic apparatuses for wireless communications, these methods do not necessarily employ those components as described or are not necessarily executed by those components. For example, the implementations of the electronic apparatuses for wireless communications may be partially or completely realized using hardware and/or firmware, while the methods for wireless communications discussed below may be completely implemented by a computer-executable program, although these methods may also employ hardware and/or firmware of the electronic apparatuses for wireless communications.

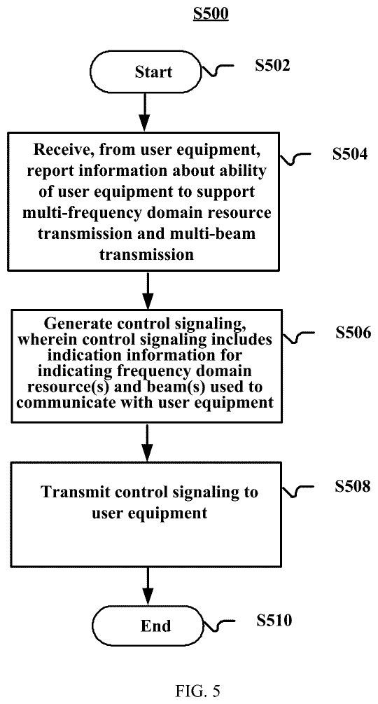

FIG. 5 shows a flowchart of a method S500 for wireless communications according to one embodiment of the present disclosure. The method S500 starts in step S502. In step S504, report information about the ability of user equipment to support multi-frequency domain resource transmission and multi-beam transmission is received from the user equipment. In step S506, control signaling is generated, wherein the control signaling includes indication information for indicating frequency domain resource(s) and beam(s) used to communicate with the user equipment, the frequency domain resource(s) and the beam(s) having binding relationship. In step S508, the control signaling is transmitted to the user equipment. The method S500 ends in step S510.

The method may be executed by, for example, the electronic apparatus 300 as described above. Please refer to the description at the above corresponding position for specific details, which will not be repeated here.

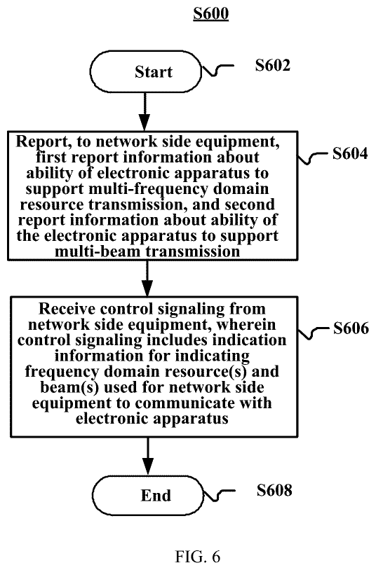

FIG. 6 shows a flowchart of a method S600 for wireless communications according to another embodiment of the present disclosure. The method S600 starts in step S602. In step S604, first report information about the ability of the electronic apparatus to support multi-frequency domain resource transmission, and second report information about the ability of the electronic apparatus to support multi-beam transmission are reported to network side equipment. In step S606, control signaling is received from the network side equipment, wherein the control signaling includes indication information for indicating frequency domain resource(s) and beam(s) used for the network side equipment to communicate with the electronic apparatus, wherein the frequency domain resource(s) and the beam(s) have binding relationship. The method S600 ends in step S608.

The method may be executed by, for example, the electronic apparatus 400 as described above. Please refer to the description at the above corresponding position for specific details, which will not be repeated here.

The technology of the present disclosure can be applied to various products.

The electronic apparatus 300 may be implemented as various network side equipment such as base stations. The base station may be implemented as any type of evolved Node B (eNB) or gNB (5G base station). An eNB includes, for example, macro eNBs and small eNBs. A small eNB may be an eNB that covers a cell smaller than a macro cell, such as a pico eNB, a micro eNB, and a home (femto) eNB. A similar situation can also apply to gNBs. Alternatively, the base station may be implemented as any other type of base station, such as a NodeB and a base transceiver station (BTS). The base station may include: a main body (also referred to as base station equipment) configured to control wireless communications; and one or more remote radio heads (RRHs) arranged at a different place from the main body. In addition, various types of user equipment can all operate as base stations by temporarily or semi-persistently performing base station functions.

The electronic apparatus 400 may be implemented as various user equipment. The user equipment may be implemented as a mobile terminal (such as a smart phone, a tablet personal computer (PC), a notebook PC, a portable game terminal, a portable/dongle type mobile router, and a digital camera) or a vehicle-mounted terminal (such as an automobile navigation device). The user equipment may also be implemented as a terminal (also referred to as a machine type communication (MTC) terminal) that executes Machine-to-Machine (M2M) communications. In addition, the user equipment may be a wireless communication module (such as an integrated circuit module including a single chip) installed on each of the above-mentioned terminals.

### Application Examples About Base Station

### First Application Example

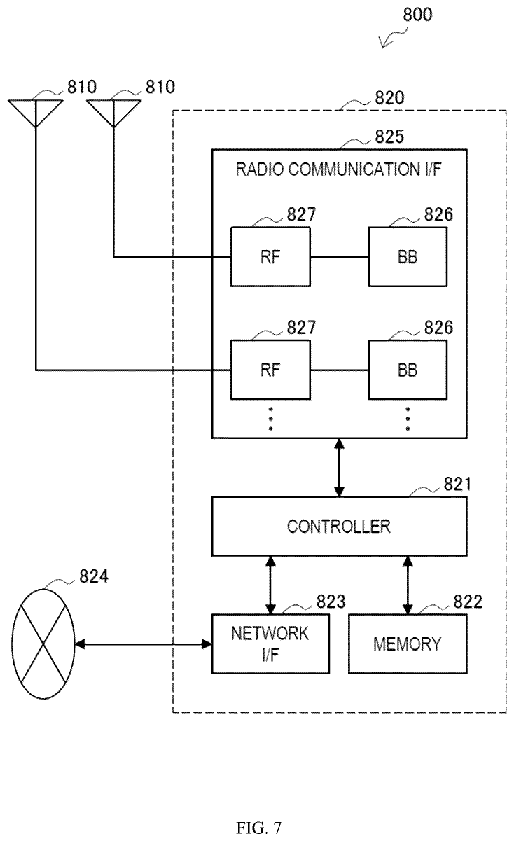

FIG. 7 is a block diagram showing a first example of a schematic configuration of an eNB or gNB to which the technology of the present disclosure can be applied. Note that, the following description takes an eNB as an example, but it may also be applied to a gNB. An eNB 800 includes one or more antennas 810 and base station equipment 820. The base station equipment 820 and each antenna 810 may be connected to each other via an RF cable.

Each of the antennas 810 includes a single or multiple antenna elements (such as multiple antenna elements included in a Multi-Input Multi-Output (MIMO) antenna), and is used for the base station equipment 820 to transmit and receive wireless signals. As shown in FIG. 7, the eNB 800 may include multiple antennas 810. For example, the multiple antennas 810 may be compatible with multiple frequency bands used by the eNB 800. Although FIG. 7 shows an example in which the eNB 800 includes multiple antennas 810, the eNB 800 may also include a single antenna 810.

The base station equipment 820 includes a controller 821, a memory 822, a network interface (I/F) 823, and a radio communication interface 825.

The controller 821 may be, for example, a CPU or a DSP, and manipulate various functions of a higher layer of the base station equipment 820. For example, the controller 821 generates a data packet based on data in a signal processed by the radio communication interface 825, and transfers the generated packet via the network interface 823. The controller 821 may bundle data from multiple baseband processors to generate a bundled packet, and transfer the generated bundled packet. The controller 821 may have a logical function for performing control such as radio resource control, radio bearer control, mobility management, admission control, and scheduling. The control may be executed in conjunction with nearby eNBs or core network nodes. The memory 822 includes an RAM and an ROM, and stores programs executed by the controller 821 and various types of control data (such as a terminal list, transmission power data, and scheduling data).

The network interface 823 is a communication interface for connecting the base station equipment 820 to a core network 824. The controller 821 may communicate with the core network node or another eNB via the network interface 823. In this case, the eNB 800 and the core network node or other eNBs may be connected to each other through a logical interface (such as an S1 interface and an X2 interface). The network interface 823 may also be a wired communication interface, or a wireless communication interface for a wireless backhaul line. If the network interface 823 is a wireless communication interface, the network interface 823 may use a higher frequency band for wireless communications than the frequency band used by the radio communication interface 825.

The radio communication interface 825 supports any cellular communication scheme (such as Long Term Evolution (LTE) and LTE-Advanced), and provides wireless connection to a terminal located in a cell of the eNB 800 via an antenna 810. The radio communication interface 825 may generally include, for example, a baseband (BB) processor 826 and an RF circuit 827. The BB processor 826 may execute, for example, encoding/decoding, modulation/demodulation, and multiplexing/demultiplexing, and execute various types of signal processing of layers (e.g., L1, Medium Access Control (MAC), Radio Link Control (RLC), and Packet Data Convergence Protocol (PDCP)). Instead of the controller 821, the BB processor 826 may have a part or all of the above-mentioned logical functions. The BB processor 826 may be a memory storing a communication control program, or a module including a processor and related circuits configured to execute the program. An update program may cause the function of the BB processor 826 to be changed. The module may be a card or blade inserted into a slot of the base station equipment 820. Alternatively, the module may also be a chip mounted on a card or blade. Meanwhile, the RF circuit 827 may include, for example, a mixer, a filter, and an amplifier, and transmit and receive a wireless signal via the antenna 810.

As shown in FIG. 7, the radio communication interface 825 may include multiple BB processors 826. For example, the multiple BB processors 826 may be compatible with multiple frequency bands used by the eNB 800. As shown in FIG. 7, the radio communication interface 825 may include multiple RF circuits 827. For example, the multiple RF circuits 827 may be compatible with multiple antenna elements. Although FIG. 7 shows an example in which the radio communication interface 825 includes multiple BB processors 826 and multiple RF circuits 827, the radio communication interface 825 may also include a single BB processor 826 or a single RF circuit 827.

In the eNB 800 as shown in FIG. 7, the transceiver of the electronic apparatus 300 described with reference to FIG. 3 may be implemented by a radio communication interface 825. At least a part of the function may also be implemented by the controller 821. For example, the controller 821 may perform indication of multi-frequency domain resources and multi-beams by executing the function of each of the units described above with reference to FIG. 3.

### Second Application Example

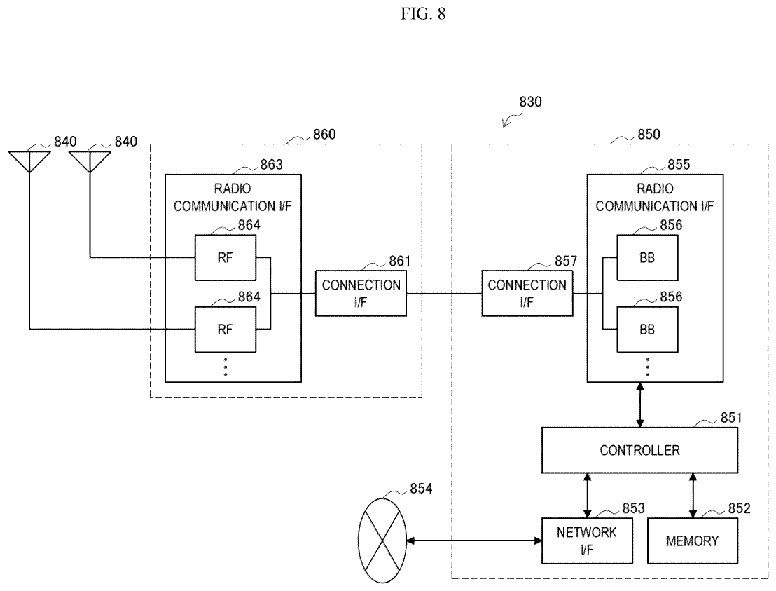

FIG. 8 is a block diagram showing a second example of a schematic configuration of an eNB or gNB to which the technology of the present disclosure can be applied. Note that similarly, the following description takes an eNB as an example, but it may also be applied to a gNB. An eNB 830 includes one or more antennas 840, base station equipment 850, and an RRH 860. The RRH 860 and each antenna 840 may be connected to each other via an RF cable. The base station equipment 850 and the RRH 860 may be connected to each other via a high-speed line such as an optical fiber cable.

Each of the antennas 840 includes a single or multiple antenna elements (such as multiple antenna elements included in a MIMO antenna) and is used for the RRH 860 to transmit and receive a wireless signal. As shown in FIG. 8, the eNB 830 may include multiple antennas 840. For example, the multiple antennas 840 may be compatible with multiple frequency bands used by the eNB 830. Although FIG. 8 shows an example in which the eNB 830 includes multiple antennas 840, the eNB 830 may also include a single antenna 840.

The base station equipment 850 includes a controller 851, a memory 852, a network interface 853, a radio communication interface 855, and a connection interface 857. The controller 851, the memory 852, and the network interface 853 are the same as the controller 821, the memory 822, and the network interface 823 as described with reference to FIG. 7.

The radio communication interface 855 supports any cellular communication scheme (such as LTE and LTE-Advanced), and provides wireless communications to a terminal located in a sector corresponding to the RRH 860 via the RRH 860 and the antenna 840. The radio communication interface 855 may generally include, for example, a BB processor 856. The BB processor 856 is the same as the BB processor 826 as described with reference to FIG. 7 except that the BB processor 856 is connected to the RF circuit 864 of the RRH 860 via the connection interface 857. As shown in FIG. 8, the radio communication interface 855 may include multiple BB processors 856. For example, the multiple BB processors 856 may be compatible with multiple frequency bands used by the eNB 830. Although FIG. 8 shows an example in which the radio communication interface 855 includes multiple BB processors 856, the radio communication interface 855 may also include a single BB processor 856

The connection interface 857 is an interface for connecting the base station equipment 850 (radio communication interface 855) to the RRH 860. The connection interface 857 may also be a communication module for communication in the above-mentioned high-speed line that connects the RRH 860 to the base station equipment 850 (radio communication interface 855).

The RRH 860 includes a connection interface 861 and a radio communication interface 863.

The connection interface 861 is an interface for connecting the RRH 860 (radio communication interface 863) to the base station equipment 850. The connection interface 861 may also be a communication module for communication in the above-mentioned high-speed line.

The radio communication interface 863 transfers and receives wireless signals via the antenna 840. The radio communication interface 863 may generally include, for example, an RF circuit 864. The RF circuit 864 may include, for example, a mixer, a filter, and an amplifier, and transfer and receive wireless signals via the antenna 840. As shown in FIG. 8, the radio communication interface 863 may include multiple RF circuits 864. For example, the multiple RF circuits 864 may support multiple antenna elements. Although FIG. 8 shows an example in which the radio communication interface 863 includes multiple RF circuits 864, the radio communication interface 863 may also include a single RF circuit 864.

In the eNB 830 as shown in FIG. 8, the transceiver of the electronic apparatus 300 described with reference to FIG. 3 may be implemented by the radio communication interface 825. At least a part of the function may also be implemented by the controller 821. For example, the controller 821 may perform indication of multi-frequency domain resources and multi-beams by executing the function of each of the units described above with reference to FIG. 3.

### Application Example About User Equipment

### First Application Example

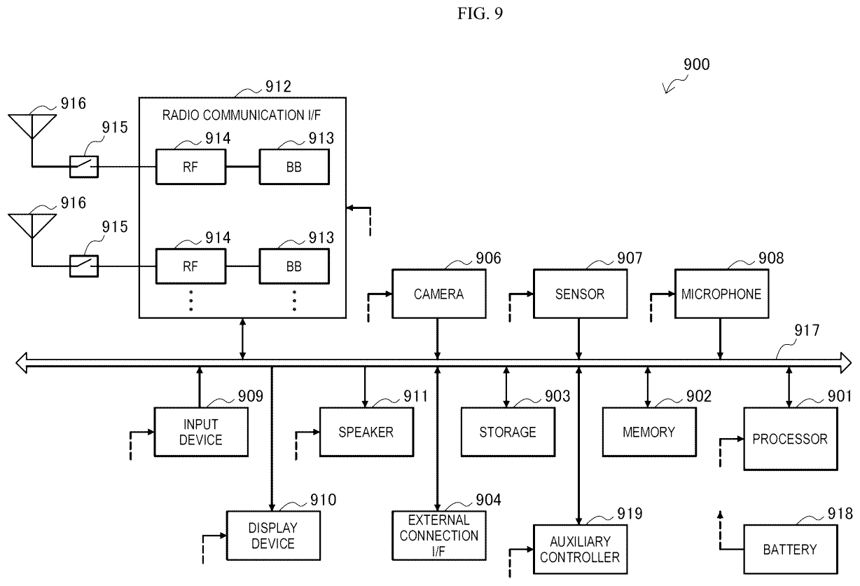

FIG. 9 is a block diagram showing an example of a schematic configuration of a smart phone to which the technology of the present disclosure can be applied. The smart phone 900 includes a processor 901, a memory 902, a storage 903, an external connection interface 904, an camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls the functions of the application layer and other layers of the smart phone 900. The memory 902 includes an RAM and an ROM, and stores data and programs executed by the processor 901. The storage 903 may include a storage medium such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetic sensor, and an acceleration sensor. The microphone 908 converts sound input to the smart phone 900 into an audio signal. The input device 909 includes, for example, a touch sensor, a keypad, a keyboard, a button, or a switch configured to detect a touch on a screen of the display device 910, and receives an operation or information input from the user. The display device 910 includes a screen (such as a liquid crystal display (LCD) and an organic light emitting diode (OLED) display), and displays an output image of the smart phone 900. The speaker 911 converts the audio signal output from the smart phone 900 into sound.

The radio communication interface 912 supports any cellular communication scheme (such as LTE and LTE-Advanced), and executes wireless communications. The radio communication interface 912 may generally include, for example, a BB processor 913 and an RF circuit 914. The BB processor 913 may execute, for example, encoding/decoding, modulation/demodulation, and multiplexing/demultiplexing, and execute various types of signal processing for wireless communications. Meanwhile, the RF circuit 914 may include, for example, a mixer, a filter, and an amplifier, and transmit and receive wireless signals via the antenna 916. Note that, although the figure shows a circumstance where one RF link is connected with one antenna, this is only schematic, and a circumstance where one RF link is connected with multiple antennas through multiple phase shifters is also included. The radio communication interface 912 may be a chip module on which the BB processor 913 and the RF circuit 914 are integrated. As shown in FIG. 9, the radio communication interface 912 may include multiple BB processors 913 and multiple RF circuits 914. Although FIG. 9 shows an example in which the radio communication interface 912 includes multiple BB processors 913 and multiple RF circuits 914, the radio communication interface 912 may also include a single BB processor 913 or a single RF circuit 914.

Furthermore, in addition to the cellular communication scheme, the radio communication interface 912 may support other types of wireless communication schemes, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits included in the radio communication interface 912 (e.g., circuits for different wireless communication schemes).

Each of the antennas 916 includes a single or multiple antenna elements (such as multiple antenna elements included in a MIMO antenna), and is used for the radio communication interface 912 to transmit and receive wireless signals. As shown in FIG. 9, the smart phone 900 may include multiple antennas 916. Although FIG. 9 shows an example in which the smart phone 900 includes multiple antennas 916, the smart phone 900 may also include a single antenna 916.

Furthermore, the smart phone 900 may include an antenna 916 for each wireless communication scheme. In this case, the antenna switch 915 may be omitted from the configuration of the smart phone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to each block of the smart phone 900 as shown in FIG. 9 via a feeder line, which is partially shown as a dashed line in the figure. The auxiliary controller 919 manipulates the least necessary function of the smart phone 900 in a sleep mode, for example.

In the smart phone 900 as shown in FIG. 9, in a case where the electronic apparatus 400 described with reference to FIG. 4 is implemented as user equipment, the transceiver of the electronic apparatus 400 may be implemented by the radio communication interface 912. At least a part of the function may also be implemented by the processor 901 or the auxiliary controller 919. For example, the processor 901 or the auxiliary controller 919 may perform indication of multi-frequency domain resources and multi-beams by executing the function of each of the units described above with reference to FIG. 4.

### Second Application Example

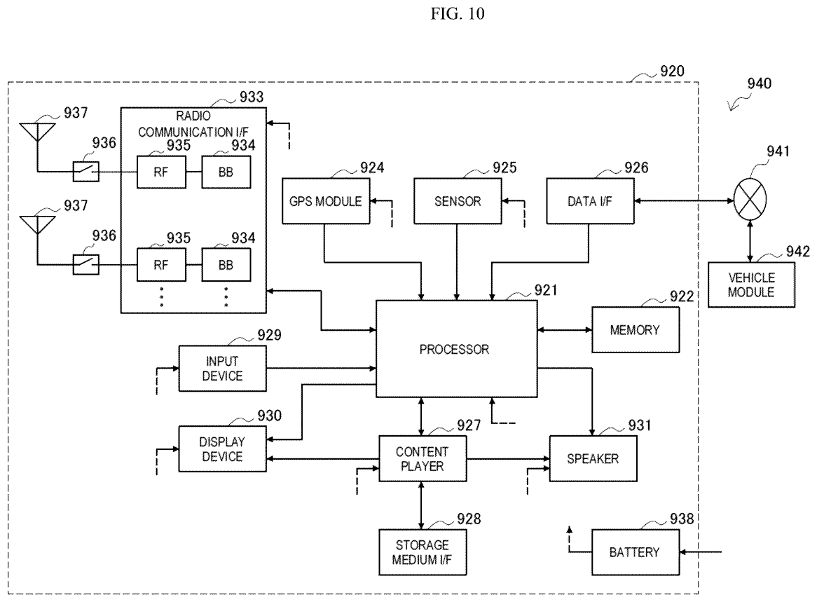

FIG. 10 is a block diagram showing an example of a schematic configuration of automobile navigation equipment to which the technology of the present disclosure can be applied. The automobile navigation equipment 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or a SoC, and controls the navigation function of the automobile navigation equipment 920 and additional functions. The memory 922 includes an RAM and an ROM, and stores data and programs executed by the processor 921.

The GPS module 924 uses a GPS signal received from a GPS satellite to measure a position of the automobile navigation equipment 920 (such as latitude, longitude, and altitude). The sensor 925 may include a group of sensors, such as a gyro sensor, a geomagnetic sensor, and an air pressure sensor. The data interface 926 is connected to, for example, an in-vehicle network 941 via a terminal not shown, and acquires data (such as vehicle speed data) generated by a vehicle.

The content player 927 reproduces content stored in a storage medium (such as a CD and a DVD), which is inserted into the storage medium interface 928. The input device 929 includes, for example, a touch sensor, a button, or a switch configured to detect a touch on a screen of the display device 930, and receives an operation or information input from the user. The display device 930 includes a screen such as an LCD or OLED display, and displays an image of a navigation function or reproduced content. The speaker 931 outputs the sound of the navigation function or the reproduced content.

The radio communication interface 933 supports any cellular communication scheme, such as LTE and LTE-Advanced, and executes wireless communication. The radio communication interface 933 may generally include, for example, a BB processor 934 and an RF circuit 935. The BB processor 934 may execute, for example, encoding/decoding, modulation/demodulation, and multiplexing/demultiplexing, and execute various types of signal processing for wireless communications. Meanwhile, the RF circuit 935 may include, for example, a mixer, a filter, and an amplifier, and transmit and receive wireless signals via the antenna 937. The radio communication interface 933 may also be a chip module on which the BB processor 934 and the RF circuit 935 are integrated. As shown in FIG. 10, the radio communication interface 933 may include multiple BB processors 934 and multiple RF circuits 935. Although FIG. 10 shows an example in which the radio communication interface 933 includes multiple BB processors 934 and multiple circuits 935, the radio communication interface 933 may also include a single BB processor 934 or a single RF circuit 935.

Furthermore, in addition to the cellular communication scheme, the radio communication interface 933 may support types of wireless communication schemes, such as a short-range wireless communication scheme, a near field communication scheme, and a wireless LAN scheme. In this case, the radio communication interface 933 may include a BB processor 934 and an RF circuit 935 for each wireless communication scheme.

Each of the antenna switches 936 switches a connection destination of the antenna 937 among multiple circuits included in the radio communication interface 933 (e.g., circuits for different wireless communication schemes).

Each of the antennas 937 includes a single or multiple antenna elements (such as multiple antenna elements included in a MIMO antenna), and is used for the radio communication interface 933 to transmit and receive wireless signals. As shown in FIG. 10, the automobile navigation equipment 920 may include multiple antennas 937. Although FIG. 10 shows an example in which the automobile navigation equipment 920 includes multiple antennas 937, the automobile navigation equipment 920 may also include a single antenna 937.

Furthermore, the automobile navigation equipment 920 may include an antenna 937 for each wireless communication scheme. In this case, the antenna switch 936 may be omitted from the configuration of the automobile navigation equipment 920.

The battery 938 supplies power to each block of the automobile navigation equipment 920 as shown in FIG. 10 via a feeder line, which is partially shown as a dashed line in the figure. The battery 938 accumulates electric power supplied from the vehicle.

In the automobile navigation equipment 920 as shown in FIG. 10, in a case where the electronic apparatus 400 described with reference to FIG. 4 is implemented as user equipment, the transceiver of the electronic apparatus 400 may be implemented by the radio communication interface 933. At least a part of the function may also be implemented by the processor 921. For example, the processor 921 may perform indication of multi-frequency domain resources and multi-beams by executing the function of each of the units described above with reference to FIG. 4.

The technology of the present disclosure may also be implemented as an in-vehicle system (or vehicle) 940 including one or more blocks in the automobile navigation equipment 920, the in-vehicle network 941, and the vehicle module 942. The vehicle module 942 generates vehicle data (such as vehicle speed, engine speed, and failure information), and outputs the generated data to the in-vehicle network 941.

The basic principle of the present invention has been described above in conjunction with specific embodiments. However, it should be pointed out that, for those skilled in the art, it could be understood that all or any step or component of the methods and devices of the present invention may be implemented in any computing device (including processors, storage media, etc.) or network of computing devices in the form of hardware, firmware, software, or a combination thereof. This can be achieved by those skilled in the art utilizing their basic circuit design knowledge or basic programming skills after reading the description of the present invention.

Moreover, the present invention also proposes a program product storing a machine-readable instruction code that, when read and executed by a machine, can execute the above-mentioned methods according to the embodiments of the present invention.

Accordingly, a storage medium for carrying the above-mentioned program product storing a machine-readable instruction code is also included in the disclosure of the present invention. The storage medium includes, but is not limited to, a floppy disk, an optical disk, a magneto-optical disk, a memory card, a memory stick, etc.

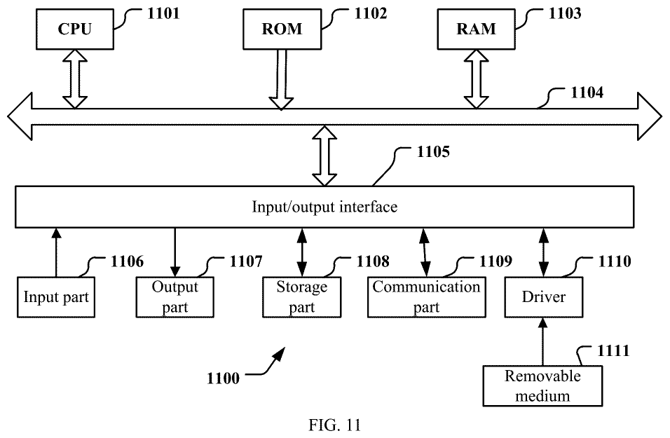

In a case where the present invention is implemented by software or firmware, a program constituting the software is installed from a storage medium or a network to a computer with a dedicated hardware structure (e.g., a general-purpose computer 1100 as shown in FIG. 11), and the computer, when installed with various programs, can execute various functions and the like.

In FIG. 11, a central processing unit (CPU) 1101 executes various processing in accordance with a program stored in a read only memory (ROM) 1102 or a program loaded from a storage part 1108 to a random access memory (RAM) 1103. In the RAM 1103, data required when the CPU 1101 executes various processing and the like is also stored as needed. The CPU 1101, the ROM 1102, and the RAM 1103 are connected to each other via a bus 1104. The input/output interface 1105 is also connected to the bus 1104.

The following components are connected to the input/output interface 1105: an input part 1106 (including a keyboard, a mouse, etc.), an output part 1107 (including a display, such as a cathode ray tube (CRT), a liquid crystal display (LCD), etc., and a speaker, etc.), a storage part 1108 (including a hard disk, etc.), and a communication part 1109 (including a network interface card such as an LAN card, a modem, etc.). The communication part 1109 executes communication processing via a network such as the Internet. The driver 1110 may also be connected to the input/output interface 1105, as needed. A removable medium 1111 such as a magnetic disk, an optical disk, a magneto-optical disk, a semiconductor memory and the like is installed on the driver 1110 as needed, so that a computer program read out therefrom is installed into the storage part 1108 as needed.

In a case where the above-mentioned series of processing is implemented by software, a program constituting the software is installed from a network such as the Internet or a storage medium such as the removable medium 1111.

Those skilled in the art should understand that, this storage medium is not limited to the removable medium 1111 as shown in FIG. 11 which has a program stored therein and which is distributed separately from an apparatus to provide the program to users. Examples of the removable media 1111 include magnetic disks (including a floppy disk (registered trademark)), an optical disk (including a compact disk read-only memory (CD-ROM) and a digital versatile disk (DVD)), a magneto-optical disk (including a mini disk (MD) (registered trademark)), and a semiconductor memory. Alternatively, the storage medium may be the ROM 1102, a hard disk included in the storage part 1108, etc., which have programs stored therein and which are distributed concurrently with the apparatus including them to users.

It should also be pointed out that in the devices, methods and systems of the present invention, each component or each step may be decomposed and/or recombined. These decompositions and/or recombinations should be regarded as equivalent solutions of the present invention. Moreover, the steps of executing the above-mentioned series of processing may naturally be executed in chronological order in the order as described, but do not necessarily need to be executed in chronological order. Some steps may be executed in parallel or independently of each other.

Finally, it should be noted that, the terms “include”, “comprise” or any other variants thereof are intended to cover non-exclusive inclusion, so that a process, method, article or apparatus that includes a series of elements not only includes those elements, but also includes other elements that are not explicitly listed, or but also includes elements inherent to such a process, method, article, or apparatus. Furthermore, in the absence of more restrictions, an element defined by sentence “including one . . . ” does not exclude the existence of other identical elements in a process, method, article, or apparatus that includes the element.

Although the embodiments of the present invention have been described above in detail in conjunction with the accompanying drawings, it should be appreciated that, the above-described embodiments are only used to illustrate the present invention and do not constitute a limitation to the present invention. For those skilled in the art, various modifications and changes may be made to the above-mentioned embodiments without departing from the essence and scope of the present invention. Therefore, the scope of the present invention is defined only by the appended claims and equivalent meanings thereof.

This technology can also be implemented as follows.

(1). An electronic apparatus for wireless communications, comprising processing circuitry configured to:
receive, from user equipment, report information about the ability of the user equipment to support multi-frequency domain resource transmission and multi-beam transmission;
generate control signaling, wherein the control signaling includes indication information for indicating frequency domain resource(s) and beam(s) used to communicate with the user equipment, the frequency domain resource(s) and the beam(s) having binding relationship; and
transmit the control signaling to the user equipment.

(2). The electronic apparatus according to (1), wherein
the indication information includes frequency domain indication information for indicating the frequency domain resource(s) and beam indication information for indicating the beam(s), and
the frequency domain resource(s) indicated by the frequency domain indication information are the same as frequency domain resource(s) where reference signals included in the beam indication information lie, or are the same as frequency domain resource(s) where reference signals having a quasi-colocation relationship with the reference signals lie.

(3). The electronic apparatus according to (2), wherein the processing circuitry is further configured to:
use the beam(s) to transmit control information on the frequency domain resource(s) to form a control channel between the electronic apparatus and the user equipment, and/or use the beam(s) to transmit data information on the frequency domain resource(s) to form a data channel between the electronic apparatus and the user equipment.

(4). The electronic apparatus according to (3), wherein the frequency domain resource(s) include(s) a plurality of frequency domain resources and the beam(s) include(s) a plurality of beams.

(5). The electronic apparatus according to (4), wherein
the processing circuitry is configured to use, on at least one frequency domain resource among the plurality of frequency domain resources, beam(s) bound to the at least one frequency domain resource to transmit the control information to form the control channel, and
the control signaling includes a Media Access Control-Control element MAC CE.

(6). The electronic apparatus according to (4), wherein
the processing circuitry is configured to:
use, on one frequency domain resource among the plurality of frequency domain resources, a beam bound to the one frequency domain resource to transmit the control information to form the control channel, and
explicitly or implicitly notify, in the control signaling, that the control signaling is used to indicate attribute information of a specific control channel,
wherein the control signaling includes Downlink Control Information DCI.

(7). The electronic apparatus according to (4), wherein
the processing circuitry is configured to use, on at least two frequency domain resources among the plurality of frequency domain resources, beam(s) bound to the at least two frequency domain resources to transmit the control information to form the control channel or to transmit the data information to form the data channel,
a value of a field indicating an ID of the frequency domain resource in the control signaling corresponds to ID(s) of at least one frequency domain resource among the plurality of frequency domain resources, and
the control signaling includes Downlink Control Information DCI.

(8). The electronic apparatus according to (7), wherein the processing circuitry is configured to notify in advance the user equipment of a corresponding relationship between the value of the field indicating the ID of the frequency domain resource and the at least one frequency domain resource.

(9). The electronic apparatus according to (8), wherein the processing circuitry is configured to perform the notification through Radio Resource Control RRC signaling and/or a Media Access Control-Control element MAC CE.

(10). The electronic apparatus according to (7), wherein the processing circuitry is configured to: for a semi-persistent scheduling that does not need the DCI activation, include information about the spectrum resource(s) and information about the beam(s) in Radio Resource Control RRC signaling.

(11). The electronic apparatus according to any one of (2) to (9), wherein the processing circuitry is configured to: when performing activation for candidate beam(s),
if the candidate beam(s) include reference signals that need to be described by frequency domain resources, activate the frequency domain resources for describing the reference signals, or
if the candidate beam(s) include reference signals that do not need to be described by frequency domain resources, activate frequency domain resource(s) where reference signals having a quasi-colocation relationship with the reference signals lie.

(12). The electronic apparatus according to any one of (7) to (9), wherein
the processing circuitry is configured to explicitly or implicitly notify, in the control signaling, that the control signaling is used to indicate attribute information of a specific control channel.

(13). The electronic apparatus according to (1), wherein the indication information includes common indication information for jointly indicating the frequency domain resource(s) and the beam(s).

(14). The electronic apparatus according to (13), wherein
the processing circuitry is configured to include information about the beam(s) in configuration information about the frequency domain resource(s) in the control signaling, so that the configuration information forms the common indication information, and
the control signaling is Radio Resource Control RRC signaling.

(15). The electronic apparatus according to (13), wherein
the processing circuitry is configured to include information about the frequency domain resource(s) in configuration information about the beam(s) in the control signaling, so that the configuration information forms the common indication information.

(16). The electronic apparatus according to (13), wherein the common indication information includes a predefined information pair for jointly indicating the frequency domain resource(s) and the beam(s).

(17). The electronic apparatus according to (16), wherein the processing circuitry is further configured to:
use the beam(s) to transmit control information on the frequency domain resource(s) to form a control channel between the electronic apparatus and the user equipment, and/or use the beam(s) to transmit data information on the frequency domain resource(s) to form a data channel between the electronic apparatus and the user equipment.

(18). The electronic apparatus according to (17), wherein
the control signaling includes a Media Access Control-Control element MAC CE or Downlink Control information DCI, to indicate the frequency domain resource(s) and the beam(s) that form the control channel.

(19). The electronic apparatus according to (17), wherein
the control signaling includes Downlink Control information DCI, to indicate the frequency domain resource(s) and the beam(s) that form the data channel.

(20). The electronic apparatus according to (19), wherein a value of a field indicating the information pair that is included in the control signaling corresponds to at least one information pair.

(21). The electronic apparatus according to (20), wherein the processing circuitry is configured to:
configure a corresponding relationship between the value of the field indicating the information pair and the at least one information pair through Radio Resource Control RRC signaling and/or Media Access Control-Control element MAC CE signaling.

(22). The electronic apparatus according to any one of (1) to (21), wherein the processing circuitry is configured to:
instruct the user equipment to perform channel measurement(s) on frequency domain resource(s) having been activated, and
generate the control signaling based on result(s) of the channel measurement(s) reported by the user equipment.

(23). The electronic apparatus according to any one of (1) to (21), wherein the processing circuitry is configured to:
generate the control signaling based on location information reported by the user equipment and location information or track information of the electronic apparatus.

(24). The electronic apparatus according to any one of (1) to (21), wherein the processing circuitry is configured to:
generate the control signaling based on a service type of the user equipment.

(25). An electronic apparatus for wireless communications, comprising processing circuitry configured to:
report, to network side equipment, first report information about the ability of the electronic apparatus to support multi-frequency domain resource transmission, and second report information about the ability of the electronic apparatus to support multi-beam transmission; and
receive control signaling from the network side equipment, wherein the control signaling includes indication information for indicating frequency domain resource(s) and beam(s) used for the network side equipment to communicate with the electronic apparatus, wherein the frequency domain resource(s) and the beam(s) have binding relationship.

(26). The electronic apparatus according to (25), wherein the processing circuitry is configured to report the first report information and the second report information, respectively.

(27). The electronic apparatus according to (26), wherein the processing circuitry is configured to transmit the first report information or the second report information in a scenario where beam(s) are bound to frequency domain resource(s).

(28). The electronic apparatus according to (25), wherein the processing circuitry is configured to simultaneously report the first report information and the second report information.

(29). The electronic apparatus according to (25), wherein
the frequency domain resource(s) include(s) a plurality of frequency domain resources, and
the processing circuitry is configured to: in a case of using only one frequency domain resource among the plurality of frequency domain resources for a downlink control channel between the network side equipment and the electronic apparatus, use the one frequency domain resource as a downlink primary frequency domain resource, and use a downlink frequency domain resource for a data channel between the network side equipment and the electronic apparatus as a downlink secondary frequency domain resource.

(30). The electronic apparatus according to (29), wherein the processing circuitry is configured to:
in a case where frequency domain resources for uplink communication have a corresponding relationship with frequency domain resources for downlink communication, use a frequency domain resource for uplink communication that corresponds to the downlink primary frequency domain resource as an uplink primary frequency domain resource, and use a frequency domain resource for uplink communication that corresponds to the downlink secondary frequency domain resource as an uplink secondary frequency domain resource.

(31). The electronic apparatus according to (29), wherein the processing circuitry is configured to:
in a case where frequency domain resources for uplink communication have no corresponding relationship with frequency domain resources for downlink communication, use a frequency domain resource for an uplink control channel that is indicated by the network side equipment as an uplink primary frequency domain resource.

(32). A method for wireless communications, comprising:
receiving, from user equipment, report information about the ability of the user equipment to support multi-frequency domain resource transmission and multi-beam transmission;
generating control signaling, wherein the control signaling includes indication information for indicating frequency domain resource(s) and beam(s) used to communicate with the user equipment, the frequency domain resource(s) and the beam(s) having binding relationship; and transmitting the control signaling to the user equipment.

(33). A method for wireless communications, comprising:
reporting, to network side equipment, first report information about the ability of the electronic apparatus to support multi-frequency domain resource transmission, and second report information about the ability of the electronic apparatus to support multi-beam transmission; and
receiving control signaling from the network side equipment, wherein the control signaling includes indication information for indicating frequency domain resource(s) and beam(s) used for the network side equipment to communicate with the electronic apparatus, wherein the frequency domain resource(s) and the beam(s) have binding relationship.

(34). A computer-readable storage medium having stored thereon computer-executable instructions that, when executed, execute the method for wireless communications according to (32) or (33).

1. An electronic apparatus for wireless communications, comprising processing circuitry configured to:
receive, from user equipment, report information about the ability of the user equipment to support multi-frequency domain resource transmission and multi-beam transmission;
generate control signaling, wherein the control signaling includes indication information for indicating frequency domain resource(s) and beam(s) used to communicate with the user equipment, the frequency domain resource(s) and the beam(s) having binding relationship; and
transmit the control signaling to the user equipment.

2. The electronic apparatus according to claim 1, wherein
the indication information includes frequency domain indication information for indicating the frequency domain resource(s) and beam indication information for indicating the beam(s), and
the frequency domain resource(s) indicated by the frequency domain indication information are the same as frequency domain resource(s) where reference signals included in the beam indication information lie, or are the same as frequency domain resource(s) where reference signals having a quasi-colocation relationship with the reference signals lie.

3. The electronic apparatus according to claim 2, wherein the processing circuitry is further configured to:
use the beam(s) to transmit control information on the frequency domain resource(s) to form a control channel between the electronic apparatus and the user equipment, and/or use the beam(s) to transmit data information on the frequency domain resource(s) to form a data channel between the electronic apparatus and the user equipment,
wherein the frequency domain resource(s) include(s) a plurality of frequency domain resources and the beam(s) include(s) a plurality of beams.

4. (canceled)

5. The electronic apparatus according to claim 3, wherein
the processing circuitry is configured to use, on at least one frequency domain resource among the plurality of frequency domain resources, beam(s) bound to the at least one frequency domain resource to transmit the control information to form the control channel, and
the control signaling includes a Media Access Control-Control element (MAC CE), or
wherein
the processing circuitry is configured to:
use, on one frequency domain resource among the plurality of frequency domain resources, a beam bound to the one frequency domain resource to transmit the control information to form the control channel, and
explicitly or implicitly notify, in the control signaling, that the control signaling is used to indicate attribute information of a specific control channel,
wherein the control signaling includes Downlink Control Information (DCI).

6. (canceled)

7. The electronic apparatus according to claim 3, wherein
the processing circuitry is configured to use, on at least two frequency domain resources among the plurality of frequency domain resources, beam(s) bound to the at least two frequency domain resources to transmit the control information to form the control channel or to transmit the data information to form the data channel,
a value of a field indicating an ID of the frequency domain resource in the control signaling corresponds to ID(s) of at least one frequency domain resource among the plurality of frequency domain resources, and
the control signaling includes Downlink Control Information (DCI).

8. The electronic apparatus according to claim 7, wherein the processing circuitry is configured to notify in advance the user equipment of a corresponding relationship between the value of the field indicating the ID of the frequency domain resource and the at least one frequency domain resource, wherein the processing circuitry is configured to perform the notification through Radio Resource Control (RRC) signaling and/or a Media Access Control-Control element (MAC CE), or
wherein the processing circuitry is configured to: for a semi-persistent scheduling that does not need the DCI activation, include information about the spectrum resource(s) and information about the beam(s) in Radio Resource Control (RRC) signaling.

9.-10. (canceled)

11. The electronic apparatus according to claim 2, wherein the processing circuitry is configured to: when performing activation for candidate beam(s),
if the candidate beam(s) include reference signals that need to be described by frequency domain resources, activate the frequency domain resources for describing the reference signals, or
if the candidate beam(s) include reference signals that do not need to be described by frequency domain resources, activate frequency domain resource(s) where reference signals having a quasi-colocation relationship with the reference signals lie.

12. The electronic apparatus according to claim 5, wherein
the processing circuitry is configured to explicitly or implicitly notify, in the control signaling, that the control signaling is used to indicate attribute information of a specific control channel.

13. The electronic apparatus according to claim 1, wherein the indication information includes common indication information for jointly indicating the frequency domain resource(s) and the beam(s).

14. The electronic apparatus according to claim 13, wherein
the processing circuitry is configured to include information about the beam(s) in configuration information about the frequency domain resource(s) in the control signaling, so that the configuration information forms the common indication information, and
the control signaling is Radio Resource Control (RRC) signaling, or
wherein
the processing circuitry is configured to include information about the frequency domain resource(s) in configuration information about the beam(s) in the control signaling, so that the configuration information forms the common indication information.

15. (canceled)

16. The electronic apparatus according to claim 13, wherein the common indication information includes a predefined information pair for jointly indicating the frequency domain resource(s) and the beam(s).

17. The electronic apparatus according to claim 16, wherein the processing circuitry is further configured to:
use the beam(s) to transmit control information on the frequency domain resource(s) to form a control channel between the electronic apparatus and the user equipment, and/or use the beam(s) to transmit data information on the frequency domain resource(s) to form a data channel between the electronic apparatus and the user equipment.

18. The electronic apparatus according to claim 17, wherein
the control signaling includes a Media Access Control-Control element (MAC CE) or Downlink Control information (DCI), to indicate the frequency domain resource(s) and the beam(s) that form the control channel.

19. The electronic apparatus according to claim 17, wherein
the control signaling includes Downlink Control information (DCI), to indicate the frequency domain resource(s) and the beam(s) that form the data channel,
wherein a value of a field indicating the information pair that is included in the control signaling corresponds to at least one information pair, and
wherein the processing circuitry is configured to:
configure a corresponding relationship between the value of the field indicating the information pair and the at least one information pair through Radio Resource Control (RRC) signaling and/or Media Access Control-Control element (MAC CE) signaling.

20.-21. (canceled)

22. The electronic apparatus according to claim 1, wherein the processing circuitry is configured to:
instruct the user equipment to perform channel measurement(s) on frequency domain resource(s) having been activated, and
generate the control signaling based on result(s) of the channel measurement(s) reported by the user equipment, or
wherein the processing circuitry is configured to:
generate the control signaling based on location information reported by the user equipment and location information or track information of the electronic apparatus, or
wherein the processing circuitry is configured to:
generate the control signaling based on a service type of the user equipment.

23.-24. (canceled)

25. An electronic apparatus for wireless communications, comprising processing circuitry configured to:
report, to network side equipment, first report information about the ability of the electronic apparatus to support multi-frequency domain resource transmission, and second report information about the ability of the electronic apparatus to support multi-beam transmission; and
receive control signaling from the network side equipment, wherein the control signaling includes indication information for indicating frequency domain resource(s) and beam(s) used for the network side equipment to communicate with the electronic apparatus, wherein the frequency domain resource(s) and the beam(s) have binding relationship.

26. The electronic apparatus according to claim 25, wherein the processing circuitry is configured to report the first report information and the second report information, respectively, and
wherein the processing circuitry is configured to transmit the first report information or the second report information in a scenario where beam(s) are bound to frequency domain resource(s).

27. (canceled)

28. The electronic apparatus according to claim 25, wherein the processing circuitry is configured to simultaneously report the first report information and the second report information.

29. The electronic apparatus according to claim 25, wherein
the frequency domain resource(s) include(s) a plurality of frequency domain resources, and
the processing circuitry is configured to: in a case of using only one frequency domain resource among the plurality of frequency domain resources for a downlink control channel between the network side equipment and the electronic apparatus, use the one frequency domain resource as a downlink primary frequency domain resource, and use a downlink frequency domain resource for a data channel between the network side equipment and the electronic apparatus as a downlink secondary frequency domain resource,
wherein the processing circuitry is configured to:
in a case where frequency domain resources for uplink communication have a corresponding relationship with frequency domain resources for downlink communication, use a frequency domain resource for uplink communication that corresponds to the downlink primary frequency domain resource as an uplink primary frequency domain resource, and use a frequency domain resource for uplink communication that corresponds to the downlink secondary frequency domain resource as an uplink secondary frequency domain resource, or
wherein the processing circuitry is configured to:
in a case where frequency domain resources for uplink communication have no corresponding relationship with frequency domain resources for downlink communication, use a frequency domain resource for an uplink control channel that is indicated by the network side equipment as an uplink primary frequency domain resource.

30.-31. (canceled)

32. A method for wireless communications, comprising:
receiving, from user equipment, report information about the ability of the user equipment to support multi-frequency domain resource transmission and multi-beam transmission;
generating control signaling, wherein the control signaling includes indication information for indicating frequency domain resource(s) and beam(s) used to communicate with the user equipment, the frequency domain resource(s) and the beam(s) having binding relationship; and
transmitting the control signaling to the user equipment.

33.-34. (canceled)
